(19) United States
(12) Patent Application Publication
(10) Pub. No.: US 2026/0288477 A1
(43) Pub. Date: Sep. 24, 2026

(54) EARLY DISPLAY ACTIVATION USING BUFFER MEMORY OF ACCELERATED PROCESSOR

(71) Applicant: ATI TECHNOLOGIES ULC, MARKHAM (CA)

(72) Inventors: Guopei Qiao, Toronto (CA); Zhan Liu, Durham (CA)

(21) Appl. No.: 19/082,412

(22) Filed: Mar. 18, 2025

(51) Int. Cl. G06F 9/4401; G06F 3/14

(52) U.S. Cl. CPC G06F 9/4405; G06F 3/14; G06F 9/4411

(57) ABSTRACT

Methods and systems are provided for enabling early display activation during a boot cycle in a computing system utilizing an accelerated processing unit (APU) with a memory buffer. During system memory initialization, display data is stored in the memory buffer of the APU and retrieved for presentation on a coupled display device, providing real-time visual feedback while memory training is performed. Memory training data is generated and saved to allow faster system initialization during subsequent boot cycles.

### BACKGROUND

Modern computing systems, particularly those incorporating high-performance processors, often require precise initialization of system components before the operating system can load. One aspect of this initialization process is the training of system memory, which ensures that memory modules operate reliably at high speeds. In systems using advanced memory technologies, such as higher generations of Double Data Rate Synchronous Dynamic Random Access Memory (DDR SDRAM, such as DDR5 memory) or similar storage types, this process involves complex calibration steps, collectively referred to as memory training.

Long memory training refers to a significant aspect of memory initialization, typically required when memory configurations are new or have been significantly modified. This process involves adjusting timing parameters, voltage levels, and signal integrity to account for variations in memory module characteristics, system board layout, and other operational factors. For instance, during an initial system boot or after changes in the system's memory configuration (e.g., adding or replacing memory modules), the system may spend up to several minutes performing this long memory training. This extended calibration is used to ensure that the memory communicates efficiently with the memory controller and functions reliably at its intended speed.

While long memory training is essential for maintaining system stability, it introduces a significant delay during the boot process. During this time, the display often remains inactive, leading to a period of perceived inactivity for the user, where no visual feedback is provided on the display. This can result in user confusion or frustration, as the user may not know whether the system is still booting or has encountered an issue.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a partial block diagram of a computer processing system that enables early display activation using buffer memory accessible by a display controller before system memory initialization completes, in accordance with one or more embodiments.

FIG. 2 illustrates a boot process typically executed by a computing system utilizing memory technologies in which regular or semi-regular initialization of that memory (including long memory training) is performed to ensure proper operation.

FIG. 3 illustrates a flowchart depicting an embodiment of another boot routine in a computer processing system, incorporating techniques for early display initialization using accessible buffer memory of an accelerated processing unit, in accordance with some embodiments.

FIG. 4 is a partial block diagram of a computer processing system incorporating techniques for early display initialization using accessible buffer memory of an accelerated processing unit, in accordance with one or more embodiments.

FIG. 5 illustrates an operational flow diagram of a routine for early display activation, in accordance with one or more embodiments.

### DETAILED DESCRIPTION

To address delays associated with long memory training, computing systems often implement methods to reduce the delay in subsequent boot cycles, relying on short memory training. After the long memory training has been performed once, optimized settings can be stored in persistent memory, such as non-volatile static random access memory (SRAM) or non-volatile Serial Peripheral Interface Read-Only Memory (SPIROM), allowing the system to retrieve these settings during future boot cycles. This results in a much faster memory initialization process, often taking only seconds. Nevertheless, there remains a need for an improved user experience during boot processes that require longer types of memory training.

Memory training is typically performed during specific system boot scenarios, such as the first cold boot of a device or the first boot following an update to system firmware (e.g., a basic input output system (BIOS) or a system BIOS (SBIOS) update). During these scenarios, the system generally performs a full calibration of the system memory before it can be accessed by other components, a process that can introduce significant delays. Because display controllers in many systems rely on system memory as a display buffer, this delay often results in an extended period where no visual feedback is provided to the user. Earlier activation of the system display during a boot cycle can provide meaningful feedback to the user during otherwise lengthy initialization procedures, improving overall system usability. A boot cycle refers to the sequence of operations performed by a computing system from the time it is powered on or restarted (rebooted) until the operating system is substantially loaded and operational. This process includes initializing hardware components, such as the processor, memory, and input/output devices, as well as executing the system firmware (e.g., BIOS or SBIOS) to prepare the computing system for loading the operating system. In certain scenarios, a boot cycle may also involve memory training, device enumeration, and peripheral initialization before transitioning control to the operating system.

Techniques described herein enable early display activation during a computing system boot cycle by utilizing accessible memory (such as on-chip SRAM associated with an acceleration processing unit (APU)) as a temporary display buffer when system memory is not yet available. Upon power-up, system firmware (e.g., SBIOS) determines whether full memory training is required, such as during a first cold boot or following an SBIOS update. If training is necessary, rather than waiting for system memory to become available, the system firmware configures the display controller to retrieve display data from a designated region of the accessible memory. This approach allows meaningful display output to be provided earlier in the boot process, reducing perceived system inactivity. Once memory training is complete and system memory becomes available, the system firmware dynamically reconfigures the display controller to transition from the temporary designated region of accessible memory to the standard system memory buffer. Because this transition occurs dynamically, no additional boot cycle is required, improving efficiency and reducing perceived startup delays.

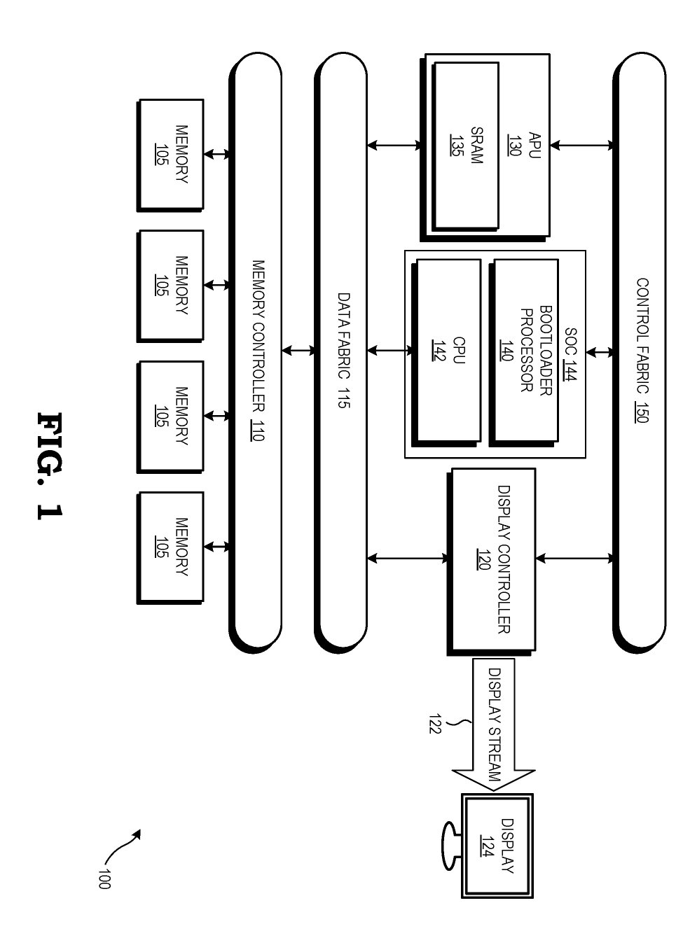

FIG. 1 is a partial block diagram of a computer processing system 100 that enables early display activation using on-chip memory accessible by a display controller 120 before system memory initialization completes, in accordance with one or more embodiments. As used herein, a memory referred to as accessible to the display controller 120 refers to a memory that can be read from or written to by the display controller 120 without requiring modifications to system hardware. In various embodiments, such accessibility may be provided via direct memory-mapped access, via an interconnect such as data fabric 115, or via some other mechanism that allows the display controller 120 to retrieve display data for output to display 124. The depicted architecture of computer processing system 100 is designed to facilitate efficient initialization of system components during the boot sequence, with a focus on interactions between memory, processing cores, and display resources.

The system includes a system-on-chip (SoC) 144, which includes a CPU 142 and a bootloader processor 140 responsible for handling early-stage initialization. The CPU 142 includes one or more general processing cores for executing system operations after initialization. The bootloader processor 140 is responsible for executing the initial stages of the boot process, including low-level system setup, memory initialization, and firmware loading. Once these tasks are completed, control is passed to one or more general processing cores of the CPU 142, which handles higher-level operations and the execution of the operating system and application software. Additional details regarding operations of the boot process are discussed elsewhere herein.

The APU 130 is connected to the computer processing system 100 via the control fabric 150 (which manages control signals and operational coordination across the system) and via the data fabric 115, which serves as a communication bus for data transfers between system memory 105, the SoC 144, and other components of the processing system 100. In various embodiments, the APU 130 comprises one or more specialized processing units, such as a neural processing unit (NPU), a graphics processing unit (GPU), a vector processing unit, or other accelerator(s) configured to execute specific computational tasks. The APU 130 includes dedicated memory resources, such as SRAM 135, which can be allocated for various operations, including temporary display buffering during system initialization. In some embodiments, the APU 130 is integrated within the SoC 144, while in other embodiments, the APU 130 is implemented as a discrete component communicatively coupled to the SoC 144 via data fabric 115 and/or control fabric 150.

A memory controller 110 manages a system memory 105, which in the depicted embodiment includes four distinct memory banks. In some embodiments, the accessible memory may include on-chip memory, such as SRAM 135 within APU 130, that is available prior to system memory initialization. In some embodiments, the memory accessible for temporarily buffering display information includes system memory 105 once initialized. The configuration of accessible memory may be dynamically adjusted during system operation based on memory availability and initialization state. It will be appreciated that in various embodiments, the system memory 105 comprises any quantity of distinct memory regions or devices. The memory controller 110 typically includes various functionalities such as error correction, scheduling, refresh cycle management, memory initialization and training, and power / datapath management.

The computer processing system 100 further includes the display controller 120, which manages the output of visual data to the display 124. The display controller receives a display stream 122 from the APU 130, which coordinates and/or generates display content for the processing system 100. This display stream data is then sent to the display 124, providing visual feedback to the user during system operation. It will be appreciated that in various embodiments, the display controller 120 is an integrated component of the computer processing system 100 as depicted, while in others the display controller 120 is a discrete external component that is communicatively coupled to the computer processing system 100 via one or both of the control fabric 150 and data fabric 115.

In the depicted embodiment, the bootloader processor 140 handles the early stages of system initialization, including memory setup and control coordination, while the CPU 142 is responsible for higher-level tasks once the system is fully initialized. The separation of these two processing units within the SoC 144 enables efficient handling of both the low-level boot sequence and the general operation of the system once the boot process is complete.

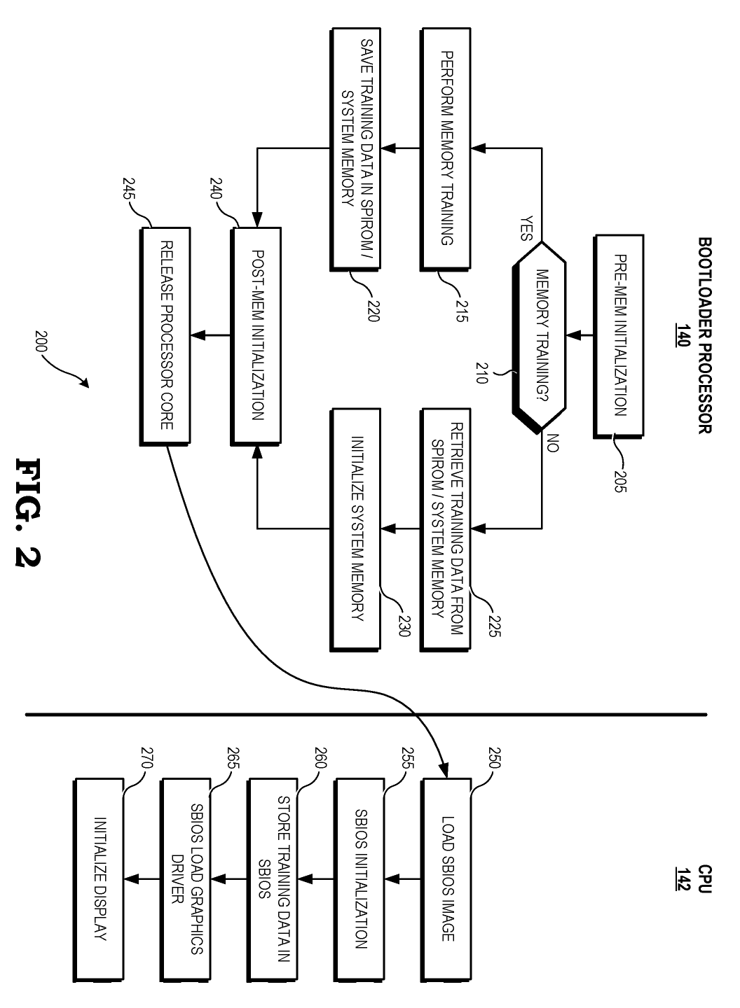

FIG. 2 illustrates a boot process 200 typically executed by a computing system utilizing memory technologies such as DDR5, in which memory initialization (including long memory training) is regularly or semi-regularly needed to ensure proper operation. In the depicted example, operations are illustrated in a bifurcated matter, with the left-hand side of the illustrated process being performed by the system’s bootloader processor and the right-hand side of the illustrated process being performed by the main processor core. As used herein, a bootloader processor refers to a specialized processing unit such as bootloader processor 140 that is responsible for initiating the system boot sequence, performing early initialization tasks before control is passed to the general processor core (e.g., a general-purpose CPU such as CPU 142). The bootloader processor typically handles low-level system setup, such as initializing hardware components, preparing memory for use, and loading essential firmware like the SBIOS. The bootloader processor (e.g., bootloader processor 140) operates during the early stages of the boot cycle, especially prior to or during system memory initialization, ensuring the system is properly configured to begin executing higher-level processes in the main processor.

The boot process begins with block 205, in which the bootloader processor performs pre-memory initialization. During this phase, the bootloader processor initializes various system components that do not rely on system memory. Following this, the routine proceeds to block 210, in which the bootloader processor determines whether memory training is to be performed.

If memory training is required, the system proceeds to block 215, in which the bootloader processor 140 (in conjunction with memory controller 110) performs memory training. Memory training calibrates the system memory to function reliably at its intended speed. This process can take a considerable amount of time, especially when long memory initialization is necessary, during which no display output is provided to the user. Once the memory training is complete, the routine proceeds to block 220, in which the bootloader processor 140 stores the resulting training data in system memory 105 for future use, enabling faster memory initialization during subsequent boot cycles.

If memory training is not required, the routine proceeds from decision block 210 to block 225, where previously stored training data is retrieved from SPIROM or system memory 105. SPIROM refers to a type of non-volatile storage that uses a Serial Peripheral Interface (SPI) bus to communicate with the system and is typically used to store firmware (such as the SBIOS) or other essential data, including memory training parameters, that must persist across power cycles. The stored training data is used in block 230 to initialize system memory (e.g., memory 105) more quickly, bypassing the need for full memory training.

After memory training, the routine proceeds to post-memory initialization (post-mem initialization 240), completing any remaining tasks that depend on initialized memory. Following this, at block 245 the bootloader processor 140 releases the CPU 142, allowing the general processor to begin executing instructions.

Once the bootloader processor 140 releases control to the CPU 142 in block 245, the system transitions to block 250, in which the SBIOS image is loaded by the CPU 142. At block 255, the CPU 142 performs SBIOS initialization, preparing various hardware components (e.g., memory and I/O devices) for further operations.

At block 260, the CPU 142 stores the resulting memory training data in the SBIOS, ensuring it is readily available for future boot cycles. In block 265, the CPU 142 loads the graphics driver (not shown) via the SBIOS, initializing display controller 120, which is responsible for controlling display output. Finally, in block 270, the CPU 142 initializes the display 124 via the display controller 120, allowing the user to view the boot progress.

In this typical boot process, no visual feedback is provided to the user during the memory training phase, leading to an extended period where the display remains blank. This can cause confusion or frustration for users who are unsure of whether the system is actively booting or has encountered an issue.

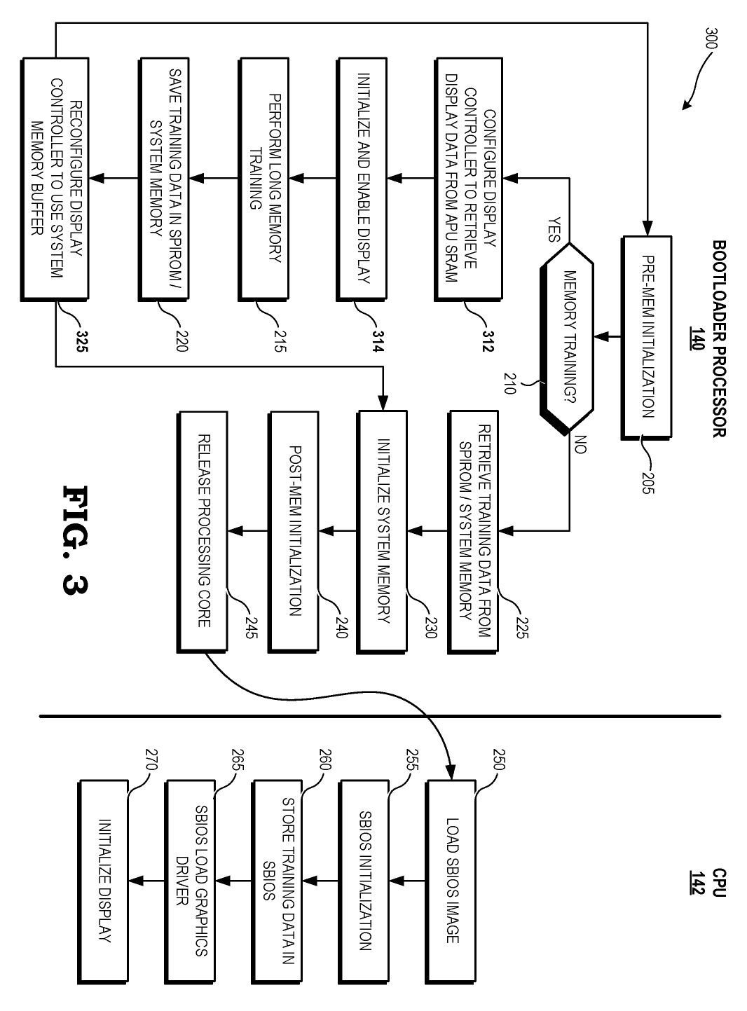

FIG. 3 illustrates a flowchart depicting an embodiment of another boot routine 300 in a computer processing system, incorporating techniques for early display initialization using a temporary display buffer in accordance with some embodiments. The system architecture and most steps mirror those of FIG. 2, but this embodiment introduces additional operations enabling early display functionality and leveraging the APU SRAM 135 as a temporary display buffer during the boot process.

The boot routine 300 begins similarly as that depicted for boot process 200 of FIG. 2, with the bootloader processor 140 executing pre-memory initialization (block 205) and determining at decision block 210 whether memory training is to be performed. If so, the routine proceeds to block 312, where the bootloader processor 140 configures the display controller 120 to retrieve display data from APU SRAM 135. Because no SBIOS and associated drivers have yet been loaded, in various embodiments and scenarios this configuration is performed via one or more direct memory access (DMA) or memory-mapped input/output (IO) operations. In either case, the bootloader processor 140 assigns the display controller 120 use of a buffer memory address corresponding to a desired display buffer location within APU SRAM 135 (or, in various embodiments, other memory accessible to the display controller 120 via data fabric 115 and/or control fabric 150). The display controller 120 then reads display data directly from the provided memory address of the temporary display buffer, which continues to function as a temporary display buffer until system memory 105 is fully initialized. This process enables early display functionality without requiring modifications to display controller hardware or firmware, as the display controller 120 operates transparently based on the assigned buffer address. In this manner, the boot routine 300 leverages the direct accessibility of APU SRAM 135 to enable early display functionality during the initial stages of the boot cycle.

Once the display controller 120 is configured to retrieve display data from APU SRAM 135, the boot routine 300 proceeds to block 314, in which the bootloader processor 140 initializes and enables the display. For example, in certain embodiments, after configuring the display controller 120 in block 312, the bootloader processor 140 directs display data (not shown) to APU SRAM 135 as part of initializing the display 124. This display data may include (as non-limiting examples) system progress indicators (e.g., a boot cycle progress indicator), diagnostic information regarding the computing system, or other visual indicia intended to be shown during the memory training process. By leveraging the direct accessibility of APU SRAM 135, the bootloader processor 140 ensures that the display data is readily available for output when the display 124 is enabled. Storing this display data in APU SRAM 135 allows the bootloader processor 140 to provide that display data as real-time feedback to the user during long memory training without waiting for the release of CPU 142 and the loading of the graphics driver at block 265, improving user experience by reducing a duration of the blackout period typically associated with the long memory training of block 215.

Following initializing and enabling the display at block 314, the bootloader processor 140 (again, in conjunction with the memory controller 110) performs memory training at block 215. While this remains a time-consuming process, especially when long memory training is required to calibrate system memory for stable operation, the display data stored in APU SRAM 135 (rather than a blank screen) may be displayed to the user during the process. Once the memory training is complete, the training data is saved in SPIROM or system memory at block 220 in the manner described above with respect to the boot process 200 of FIG. 2.

After completing memory training and storing the data, the boot routine 300 proceeds to block 325, in which the bootloader processor 140 reconfigures the display controller 120 to use system memory 105 as its display buffer. Similar to the configuration performed at block 312, this is accomplished via one or more direct memory access (DMA) or memory-mapped IO operations, in which the bootloader processor 140 assigns the display controller 120 a new memory address corresponding to system memory 105. The display controller 120 then begins retrieving display data from system memory instead of APU SRAM 135. Because this transition occurs at the firmware level and does not rely on an SBIOS driver, it allows for a seamless switch to system memory without requiring a reboot or interrupting display functionality.

Following this transition, the routine proceeds to block 230, in which system memory 105 is initialized. This ensures that all necessary memory regions are properly configured for normal operation. Once system memory is available, the system executes post-memory initialization tasks at block 240, after which the bootloader processor 140 releases CPU 142 at block 245, allowing the CPU to take control of the system and continue execution.

From this point forward, the routine proceeds through the remainder of the boot sequence as described with respect to FIG. 2. In particular, CPU 142 loads the SBIOS image at block 250, performs SBIOS initialization at block 255, and stores memory training data at block 260. At block 265, CPU 142 loads the graphics driver, and at block 270, the display 124 is fully initialized under standard operation, completing the boot process.

Thus, in the depicted embodiment, the introduction of using APU SRAM 135 as a temporary display buffer (block 312) and early display initialization (block 314) provides significant improvement to user experience during the boot cycle (and optimizes memory usage during long memory training processes) by reducing the delay before visual feedback is provided.

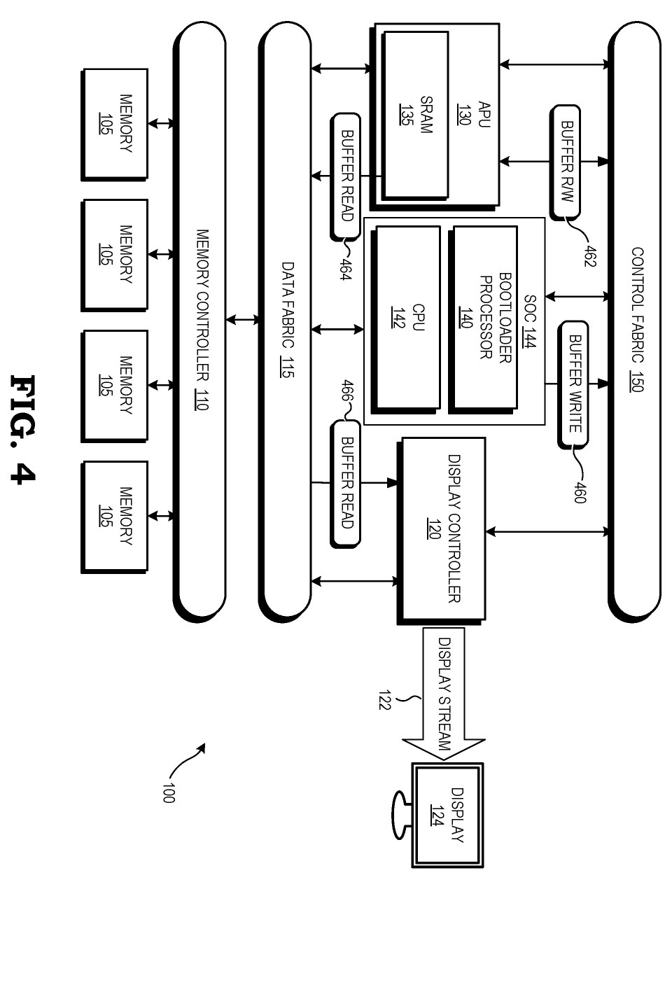

FIG. 4 is a block diagram of a computer processing system 100 that utilizes both an APU 130 and one or more general processing cores of CPU 142, incorporating techniques for early display activation using a temporary display buffer in accordance with one or more embodiments. This embodiment is similar to the architecture shown in FIG. 1, but introduces additional operations leveraging the SRAM 135 of the APU 130 to temporarily store and manage display data during the system’s boot sequence, such as before system memory 105 is fully initialized.

The system-on-chip (SoC 144) includes both the bootloader processor 140 and the CPU 142. As described elsewhere herein with respect to FIGS. 1-3, the bootloader processor 140 is responsible for early system initialization tasks, while the CPU 142 handles higher-level operations after the initial boot process is complete.

The APU 130 is communicatively coupled to the bootloader processor 140 and other components of computing system 100 via both the control fabric 150 (for managing control signals) and the data fabric 115 (for managing data transfers between memory and other components). In the depicted embodiment, operations using the SRAM 135 of APU 130 are utilized to facilitate early boot cycle tasks, as described below.

At block 460, a buffer write operation is performed by the bootloader processor 140, which writes display data to the SRAM 135 of APU 130. For example, and as noted elsewhere herein, this display data may include system progress indicators, diagnostic information, or other visual content to be displayed before system memory 105 is fully available.

Block 462 illustrates the bootloader processor 140 performing both read and write (R/W) operations using the SRAM 135 of APU 130. This allows the bootloader to manage temporary display data storage in the buffer while memory training or other initialization tasks are in progress, improving boot performance and enabling early system functionality.

At block 464, a buffer read operation is performed by the bootloader processor 140. This allows the bootloader processor to retrieve display data from SRAM 135 as needed during the early stages of the boot process, ensuring display continuity prior to system memory initialization.

At block 466, another buffer read operation is performed by the display controller 120, which retrieves display data stored in SRAM 135. This retrieval enables the display controller 120 to generate the display stream 122 for output to the display 124, providing the user with visual indicia during memory training or other lengthy initialization processes.

Thus, in the depicted embodiment, the memory controller 110 continues to manage access to the system's main memory 105, while the buffer operations described herein using the accessible memory of the APU SRAM 135 enable the system to function efficiently during the early boot stages, before system memory 105 is fully initialized. By using the APU SRAM 135 in this way, the computer processing system 100 reduces reliance on system memory 105 during the boot cycle, enhancing user experience by providing earlier visual feedback.

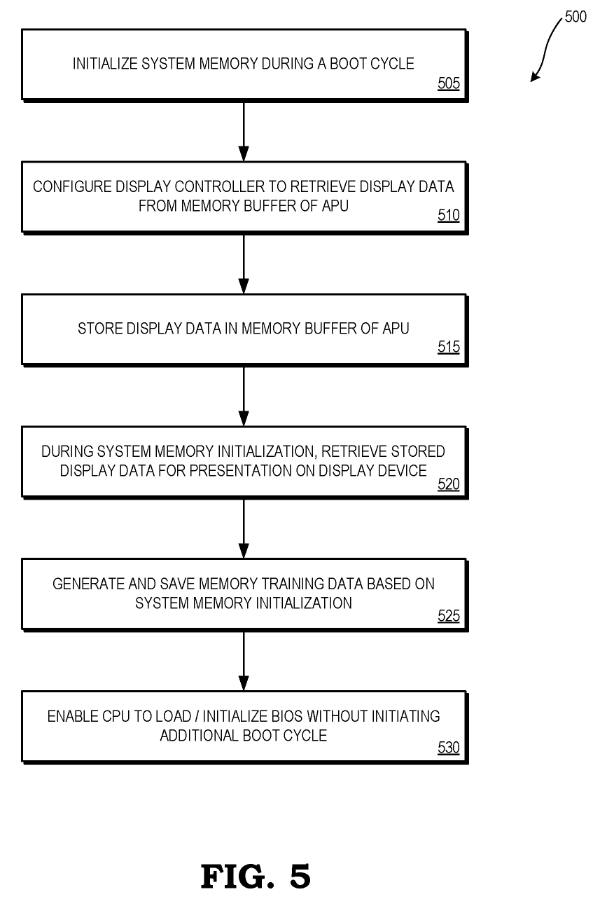

FIG. 5 illustrates an operational flow diagram of a routine 500 for early display activation using a memory buffer of an accelerated processing unit (APU), in accordance with one or more embodiments. The routine 500 may be performed, for example, by a bootloader processor (e.g., bootloader processor 140 of FIGS. 1 and 4) in a computing system having an APU (e.g., APU 130) communicatively coupled to a central processing unit (CPU) (e.g., CPU 142).

The routine 500 begins at block 505, in which the bootloader processor initializes the system memory of the computing system during a boot cycle. This system memory initialization may include performing memory training to calibrate the system memory for stable operation, which can be time-consuming in cases of long memory training. The routine proceeds to block 510.

At block 510, the bootloader processor configures the display controller 120 to retrieve display data from a memory buffer of the APU. Because system memory 105 is not yet initialized at this stage, the display controller 120 is provided with a memory address corresponding to the memory buffer of the APU, allowing it to retrieve display data via direct memory access (DMA) or memory-mapped IO. The routine proceeds to block 515.

At block 515, the bootloader processor stores display data in the memory buffer of the APU. This display data may include boot progress indicators, diagnostic information, or other visual data intended for output to the display device 124 during the memory initialization process. By leveraging the APU’s dedicated memory buffer, the system ensures that display data is available for early retrieval. The routine proceeds to block 520.

At block 520, during the initialization of the system memory, the system retrieves the stored display data from the memory buffer of the APU and presents it on the display device. This step enables early visual feedback during boot, reducing the perceived "blackout" period typically experienced by users during memory training. The routine proceeds to block 525.

At block 525, the system generates and saves memory training data based on the initialization of the system memory. The memory training data is saved in SPIROM or system memory 105 for use in subsequent boot cycles, enabling faster system memory initialization. The routine proceeds to block 530.

At block 530, the bootloader processor enables the CPU 142 to load and initialize the system BIOS (SBIOS) without requiring an additional boot cycle.

In some embodiments, the apparatus and techniques described above are implemented in a system including one or more integrated circuit (IC) devices (also referred to as integrated circuit packages or microchips), such as the computing system and related operations described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]-is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
initializing a system memory during a boot cycle of a computing system having an accelerated processing unit (APU) communicatively coupled to a general processing core;
storing display data in a memory buffer of the APU; and
during the initializing of the system memory, retrieving the stored display data from the memory buffer of the APU for presentation on a display device of the computing system.

2. The method of claim 1, wherein initializing the system memory comprises generating memory training data for the system memory, and wherein the method further comprises saving the memory training data.

3. The method of claim 1 further comprising, subsequent to the retrieving of the stored display data from the memory buffer of the APU for presentation, enabling the general processing core to load and initialize a basic input output system (BIOS) of the computing system without initiating an additional boot cycle of the computing system.

4. The method of claim 1, wherein the general processing core is communicatively coupled to a bootloader processor that performs the method.

5. The method of claim 1, wherein retrieving the stored display data from the memory buffer of the APU for presentation on the display device comprises configuring a controller of the display device to retrieve the stored display data from the memory buffer.

6. The method of claim 5, wherein configuring the controller of the display device comprises one or more direct memory access (DMA) or memory-mapped input/output (IO) operations to provide the controller of the display device with a memory address corresponding to the memory buffer of the APU.

7. The method of claim 1, wherein the memory buffer of the APU comprises one or more memory locations within a static random-access memory (SRAM) of the APU.

8. The method of claim 1, further comprising updating, during the initializing of the system memory, the display data stored in the memory buffer for presentation on the display device.

9. The method of claim 1, wherein the display data stored in the memory buffer for presentation on the display device comprises one or more of a group that includes a boot cycle progress indicator, diagnostic information, or status information regarding the computing system.

10. A computing system, comprising:
an accelerated processing unit (APU) having a memory buffer;
a general processing core communicatively coupled to the APU; and
a system memory;
wherein the computing system is configured to:
initialize the system memory during a boot cycle;
store display data in the memory buffer of the APU; and
during the initialization of the system memory, retrieve the stored display data from the memory buffer for presentation on a display device that is communicatively coupled to the computing system.

11. The computing system of claim 10, wherein the system memory initialization comprises generating memory training data for the system memory, and wherein the computing system is further configured to save the memory training data for future use after the system memory initialization.

12. The computing system of claim 10, wherein the memory buffer of the APU comprises one or more memory locations within a static random-access memory (SRAM) of the APU.

13. The computing system of claim 10 further comprising, subsequent to the retrieval of the stored display data from the memory buffer for presentation, enabling the general processing core to load and initialize a basic input output system (BIOS) of the computing system without initiating an additional boot cycle of the computing system.

14. The computing system of claim 13, further comprising a bootloader processor communicatively coupled to the general processing core, wherein the bootloader processor is configured to initialize the system memory and to enable the general processing core to load and initialize the BIOS.

15. The computing system of claim 10, wherein to retrieve the stored display data from the memory buffer of the APU for presentation on the display device comprises configuring a controller of the display device to retrieve the stored display data from the memory buffer.

16. The computing system of claim 15, wherein to configure the controller of the display device comprises providing the controller with a memory address corresponding to the memory buffer of the APU.

17. The computing system of claim 10, wherein the computing system is further configured to update, during the initialization of the system memory, the display data stored in the memory buffer for presentation on the display device.

18. The computing system of claim 10, wherein the display data stored in the memory buffer comprises one or more of a group that includes a boot cycle progress indicator, diagnostic information, or status information regarding the computing system.

19. A bootloader processor configured to, during a boot cycle of a computing system:
initialize a system memory of the computing system;
store display data in a memory buffer of an accelerated processing unit (APU), wherein the APU is communicatively coupled to a general processing core of the computing system; and
during initialization of the system memory, retrieve the stored display data from the memory buffer of the APU for presentation on a display device communicatively coupled to the computing system.

20. The bootloader processor of claim 19, further configured to enable, subsequent to the retrieval of the stored display data from the memory buffer for presentation, the general processing core to load and initialize a basic input output system (BIOS) of the computing system without initiating an additional boot cycle of the computing system.
